(19) United States
(12) Patent Application Publication
(10) Pub. No.: US 2005/0096087 A1
(43) Pub. Date: May 5, 2005

(54) Portable terminal capable of copying data between subscriber identification module cards and data copy method using the same

(75) Inventor: Pil-Jun Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/916,050

(22) Filed: Aug. 11, 2004

(30) Foreign Application Priority Data
Nov. 3, 2003 (KR) 77320-2003

(51) Int. Cl. H04M 1/00

(52) U.S. Cl. 455/558; 455/550.1

(57) ABSTRACT

Disclosed herein is a portable terminal capable of copying data between subscriber identification module cards. The terminal includes a subscriber identification module (SIM) interface connected to the SIM card, for providing an interface for exchanging data with the SIM card; an operation key including a service menu key installed for providing a service to a user and a SIM control key for controlling data exchange to the SIM card connected to the SIM interface; a storage section for storing data lists stored in the SIM card and data type information; and a control section for storing the data, which are stored in the SIM card connected to the SIM interface, in an internal storage medium, and storing the data stored in the internal storage medium in another SIM card when the another SIM card is connected to the SIM interface.

### PRIORITY

This application claims priority to an application entitled “Portable Terminal Capable Of Copying Data Between Subscriber Identification Module Cards And Data Copy Method Using The Same” filed in the Korean Intellectual Property Office on Nov. 3, 2003 and assigned Serial No. 2003-77320, the contents of which are hereby incorporated by reference.

### BACKGROUND OF THE INVENTION

1. Field of the Invention

The present invention relates to a portable terminal which can detachably contain a subscriber identification module card, and more particularly to a portable terminal which can detachably house a subscriber identification module card and which enables data stored in the subscriber identification module card to be copied or stored to another subscriber identification module card.

2. Description of the Related Art

Recently, with the rapid development of mobile communication, several providers of global mobile roaming service allow users to receive mobile communication service regardless of whether the user travels between different countries Only a single number need be assigned to the user who wishes receive such global service. In order to receive such a service, a portable terminal having a subscriber identification module (SIM) card has been proposed.

The SIM card is a subscriber identification module and stores user profile information. When the SIM card is connected to a connector of the portable terminal, which detachably houses the SIM card and can provide a mobile communication service, the portable terminal will read the user profile information stored in the SIM card in order to provide services via a phone number included in the read profile information.

Such portable terminals which can detachably house a SIM card have become a standard in Europe for providing a global system for mobile communication (GSM). Portable terminals which detachably house a SIM card have not yet been introduced in a code division multiple access (CDMA) systems that are in use in Korea. However, China Unicom in China has released a CDMA portable terminal provided with SIM card.

The portable terminal which can detachably house the SIM card allows a user to use any such portable terminal as her or her own terminal, as long as the user provides his or her own SIM card. Even if a user goes to another country and rents a different portable terminal which can accept a SIM card, the rented portable terminal can be used as if it were the user's own terminal, so long as the user attaches his or her own SIM card to the rented terminal.

Further, since a SIM card, which may be applied to the portable terminal, has superior security, it thus has a high utility even in electronic commerce, etc. Furthermore, a SIM card mounted on the portable terminal can additionally store data such as a short message or a phone book, etc.

FIG. 1 is a block diagram showing a connection state of a computer and a portable terminal provided with a SIM card.

When a user wants to transfer data stored in a first SIM card 22 to a second SIM card 24, it is necessary to have a computer 10, which can be connected to a portable terminal 20 to exchange data, and an application program 12 installed on the computer 10. At this time, when the portable terminal 20 provided with the first SIM card 22 is connected to the computer 10, the computer 10 recognizes the first SIM card 22 mounted on the portable terminal 20 as a portable storage medium.

The user transfers data stored in the first SIM card 22, which is mounted on the portable terminal 20, and stores the data in a storage medium 14 of the computer 10. Then, the user inserts the second SIM card 24 into the portable terminal 20, and the data stored in the storage medium 14 of the computer 10 can be transferred to and stored in the second SIM card 24, which is now mounted on the portable terminal 20.

However, in order to move data stored in the first SIM card 22 and to store the moved data in the second SIM card 24, it is necessary to have a computer 10, a cable 16 for connecting the computer 10 to the portable terminal 20, and the application program 12 installed on the computer 10. The application program 12 recognizes the first and second SIM cards 22 and 24, and facilitates transfer of the data stored in the first SIM card 22. That is, in order to move data stored in the first SIM card 22 and to store the moved data in the second SIM card 24, the devices and the program described above are required.

Accordingly, without a computer capable of recognizing the SIM cards and exchanging data, the data stored in the first SIM card 22 cannot be transferred and stored in the second SIM card 24.

### SUMMARY OF THE INVENTION

Accordingly, the present invention has been made to solve the above-mentioned problems occurring in the prior art. A first object of the present invention is to provide a portable terminal, and a method for using the same, which provides a simper construction and manner of transferring data stored in a first subscriber identification module (SIM) card mounted on the portable terminal and storing the moved data in a second SIM card.

A second object of the present invention is to provide a portable terminal and method, which can transfer data stored in a first SIM card to a second SIM card without the need to connect the portable terminal to a computer having an application program for recognizing the SIM card mounted on the portable terminal.

In order to accomplish the aforementioned objects, according to one aspect of the present invention, there is provided a portable terminal which can detachably house a subscriber identification module card, the portable terminal comprising: a subscriber identification module interface connected to the subscriber identification module card, for providing an interface for exchanging data with the subscriber identification module card; an operation key including a service menu key installed for providing a service to a user and a SIM control key for controlling data exchange to the subscriber identification module card connected to the subscriber identification module interface; a storage section for storing data lists stored in the subscriber identification module card and data type information; and a control section for storing the data, which are stored in the subscriber identification module card connected to the subscriber identification module interface, in an internal storage medium, and storing the data stored in the internal storage medium in another subscriber identification module card when the another subscriber identification module card is connected to the subscriber identification module interface.

Preferably, the control section detects lists of data stored in the subscriber identification module card connected to the subscriber identification module interface, determines the type of detected data, displays a list from among the detected lists, the list corresponding to an input of the service menu key, detects data from the subscriber identification module card to store the detected data in the internal storage medium, the data corresponding to a list receiving a storage command to an internal storage medium from among the displayed list, and selectively stores the data stored in the internal storage medium in another subscriber identification module card when the another subscriber identification module card is newly connected to the subscriber identification module interface.

Also, the data stored in the internal storage medium after being detecting from the subscriber identification module card may include at least one of a short message, an electronic book, a picture, a dynamic image, and music information.

In order to accomplish the aforementioned objects, according to one aspect of the present invention, there is provided a method for copying subscriber identification module data stored in a subscriber identification module card using a portable terminal, the portable terminal including a subscriber identification module interface connected to the subscriber identification module card, an operation key having a service menu key installed for providing a service to a user and a SIM control key for controlling data exchange to the subscriber identification module card, and a storage section for storing data lists stored in the subscriber identification module card and data type information, the method comprising the steps of: a) determining whether the subscriber identification module card is connected to the subscriber identification module interface; b) detecting data stored in the subscriber identification module card to store the detected data in an internal storage medium when it is determined that the subscriber identification module card is connected to the subscriber identification module interface; and c) detecting the data stored in the internal storage medium and selectively storing the detected data in another subscriber identification module card when the another subscriber identification module card is newly connected to the subscriber identification module interface.

Preferably, the method further comprises: detecting lists of the data stored in the subscriber identification module card and determining the type of detected data when it is determined that the subscriber identification module card is connected to the subscriber identification module interface in step a); displaying lists of data corresponding to a selection signal from among the detected lists when the selection signal of the service menu key installed for a service is inputted; and detecting data corresponding to a selected list from the subscriber identification module card and storing the detected data in the internal storage medium according to a storage command when the storage command, which requires at least one list to be selected from among the displayed lists and the selected list to be stored in the internal storage medium, is inputted.

Also, the method further comprises: detecting the data corresponding to the selected list from the subscriber identification module card and displaying the detected data according to a display command when the display command, which requires at least one list to be selected from among the displayed lists and the selected list to be displayed, is inputted; and storing the displayed data in the internal storage medium when a storage command, which requires the displayed data to be stored in the internal storage medium, is inputted.

According to the present invention, a SIM card mounted on a portable terminal is recognized, so that data stored in the SIM card is automatically or selectively stored in an internal storage medium of the portable terminal. If another SIM card is mounted on the portable terminal, the data stored in the internal storage medium are automatically or selectively stored in the new SIM card. Accordingly, the data stored in the SIM card can be easily copied into the another SIM card without connecting the SIM card to another device.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a connection state of a computer and a portable terminal provided with a subscriber identification module card;

FIG. 2 is a block diagram showing a portable terminal which can copy subscriber identification module data stored in a SIM card according to an embodiment of the present invention; and

FIGS. 3 and 4 are flowcharts illustrating a method for copying data stored in a SIM card using a portable terminal according to an embodiment of the present invention.

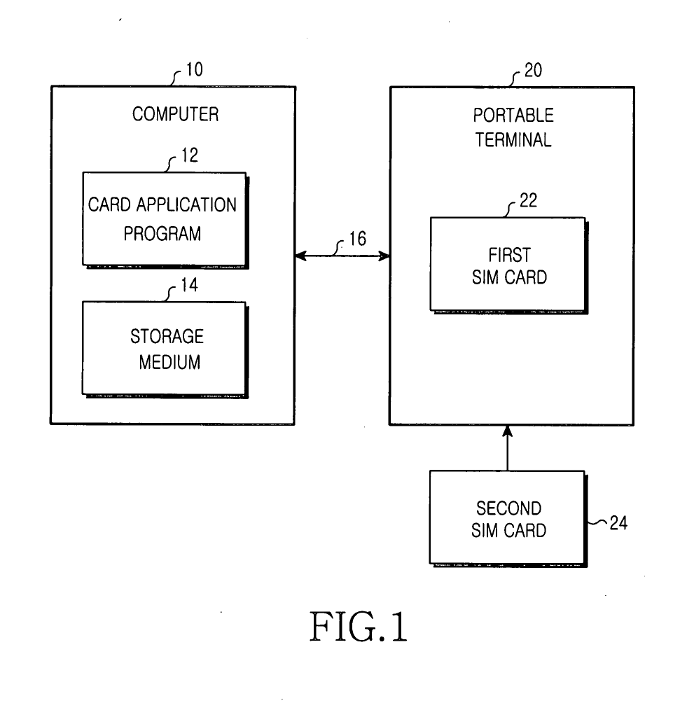

### DETAILED DESCRIPTION OF THE PREFERRED EMBODIMENTS

Hereinafter, preferred embodiments according to the present invention will be described with reference to the accompanying drawings. The same reference numerals are used to designate the same elements as those shown in other drawings. In the below description, many particular items, such as detailed elements of circuit, are shown, but these are provided for helping the general understanding of the present invention, and it will be understood by those skilled in the art that the present invention can be embodied without particular items. In the following description of the present invention, a detailed description of known functions and configuration incorporated herein will be omitted when to avoid making the subject matter of the present invention unclear.

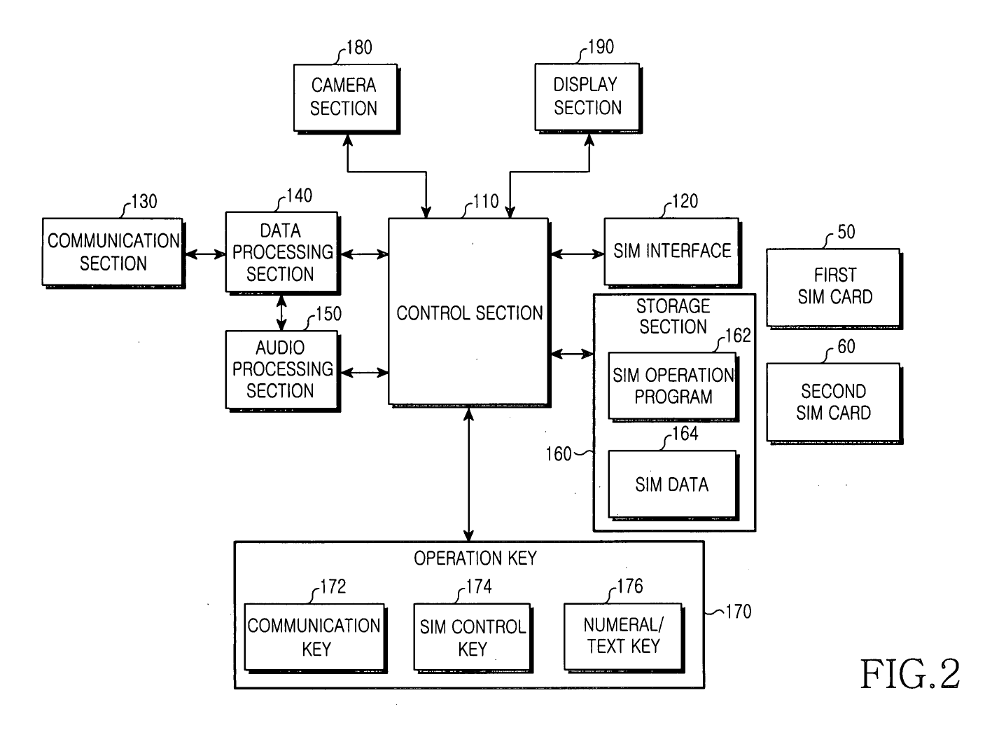

FIG. 2 is a block diagram showing a portable terminal which can copy subscriber identification module data stored in a SIM card according to an embodiment of the present invention.

First, a communication section 130 performs wireless communication functions of a portable terminal, and includes a RF transmitter (not shown) for transforming, amplifying and transmitting a high frequency signal, and a RF receiver (not shown) for low-noise amplifying a received signal and transforming the frequency of the amplified signal into a low frequency.

A data processing section 140 includes a modem (not shown) for coding and modulating the signal transmitted from the communication section 130, and a codec (not shown) for demodulating and decoding the signal received by the communication section 130. Herein, the codec includes a data codec for processing packet data, etc., and an audio codec for processing an audio signal such as voice data.

An audio processing section 150 reproduces the audio signal outputted from the audio codec of the data processing section 140 so as to output the reproduced signal through a speaker (not shown), or transmits an audio signal, which is inputted via a microphone (not shown), to the audio codec of the data processing section 140.

A control section 110 controls a general operation of the portable terminal. Further, the control section 110 drives a photographing program stored in a storage section 160 to control a camera section 180, thereby operating camera functions. In addition, the control section 110 can drive programs stored in the storage section 160 according to commands outputted from an operation key 170, and drive corresponding operations.

The camera section 180 is provided to allow photographing of an image of a subject imaged through a lens (not shown), and includes a camera sensor (not shown) for converting a photographed optical signal into an electrical signal and a signal processing section (not shown) for converting an analog image signal photographed from the camera sensor into digital data. Herein, it is assumed that the camera sensor is a charge coupled device (CCD). The signal processing section may include a digital signal processor (DSP). Further, the camera sensor may be integrated with the signal processing section, or vice versa. A display section 190 displays an operation state of the portable terminal.

A SIM interface 120 includes a connector to which a SIM card can be mounted, and provides an interface for exchanging data between the mounted SIM card and the control section 110.

The operation key 170 includes a communication key 172 for enabling input of a communication command, a SIM control key 174 for controlling an operation related to the SIM card mounted on the SIM interface 120, and a numeral/text key 176 for inputting numerals and/or text characters.

The storage section 160 stores not only programs necessary for operation of the portable terminal, but also stores a SIM operation program 162 related to the SIM card and SIM data 164, which is data detected and transferred from the SIM card, according to the present embodiment.

When the control section 110 detects that a first SIM card 50 is mounted on the SIM interface 120, the control section 110 drives the SIM operation program 162 stored in the storage section 160 so as to recognize the first SIM card 50 as an exterior storage medium and registers the first SIM card 50. At this time, the control section 110 detects whether data lists are stored in the first SIM card 50, and determines the type of data corresponding to the detected list. Then, the control section 110 temporarily stores the data lists and data type information in the storage section 160. The data are provided through an operation of the portable terminal, and include a short message, an electronic book, a picture, a dynamic image, or music information, etc.

When a signal generated by selecting a menu key installed for providing a service is inputted from the operation key 170, the control section 110 detects a data list corresponding to the selected menu key from among the data lists stored in the storage section 160 and displays the detected data list on the display section 190. At this time, when a command, which requires a list to be selected and data corresponding to the selected list to be stored in an internal storage medium, is inputted via the SIM control key 174 of the operation key 170, the control section 110 detects the data corresponding to the selected list from the first SIM card 50 and stores the detected data in the internal storage medium. Herein, the internal storage medium represents the storage section 160, and the data, which are detected from the first SIM card 50 to be stored in storage section 160, are called the SIM data 164.

After the data detected from the first SIM card 50 is stored in storage section 160, if the first SIM card 50 is separated or disconnected from the SIM interface 120, the control section 110 will delete a registered exterior storage medium list. In contrast, if the first SIM card 50 is reconnected to the SIM interface 120, the control section 110 recognizes the first SIM card 50 again and registers the first SIM card 50 as the exterior storage medium.

Meanwhile, when the first SIM card 50 is separated from the SIM interface 120 and a second SIM card 60 is connected to the SIM interface 120, the control section 110 performs an initialization process of registering the second SIM card 60 as the exterior storage medium. At this time, the control section 110 detects data lists stored in the second SIM card 60, determines the type of detected data, and stores data type information in the storage section 160. Further, the control section 110 enables the data lists, which are stored in the storage section 160 of the internal storage medium after being detected from the first SIM card 50, to be displayed via the display section 190.

When a command is inputted that requires a list to be selected from among the data lists displayed via the display section 190 and that requires data corresponding to the selected list to be stored in the second SIM card 60 of the exterior-storage medium, the control section 110 stores the data corresponding to the selected list in the second SIM card 60.

As described above, according to the present invention, a first SIM card mounted on a portable terminal is recognized, so that data stored in the SIM card can be automatically or selectively stored in an internal storage medium of the portable terminal. If the first SIM card is removed and another SIM card is mounted on the portable terminal, the data stored in the internal storage medium can automatically or selectively be stored in the new mounted, second SIM card. Accordingly, the data stored on a SIM card can be easily copied to another SIM card, without the need to connect the SIM card to a separate device.

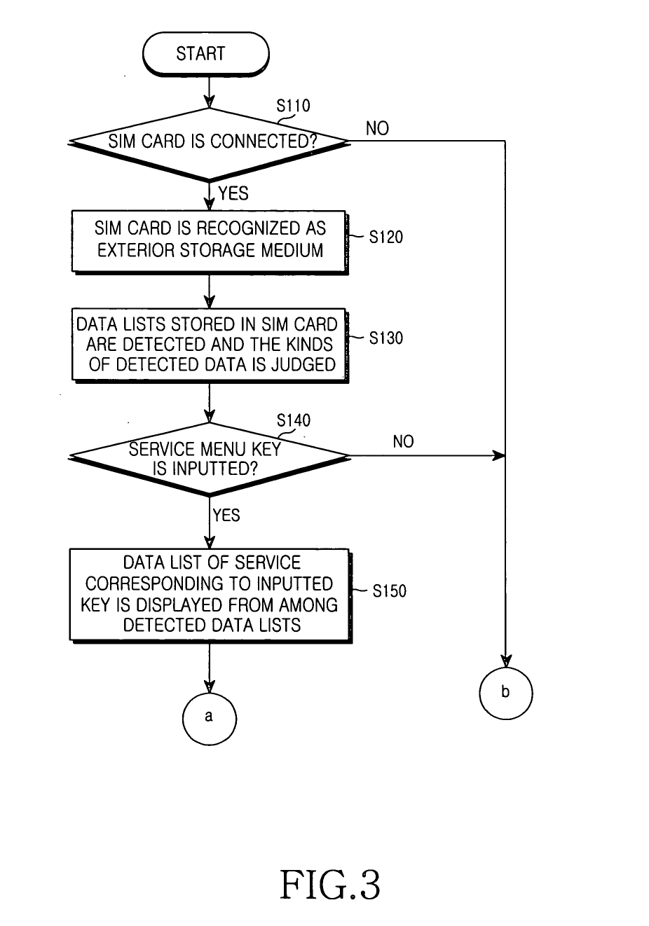

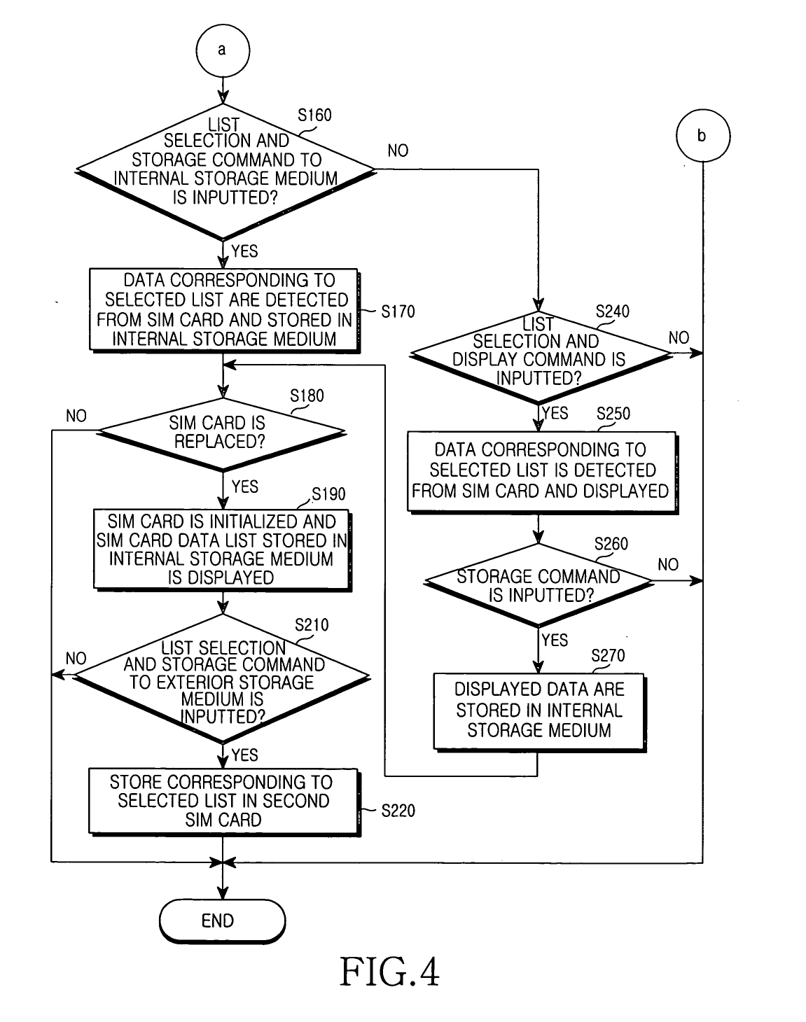

FIGS. 3 and 4 are flowcharts illustrating a method for copying data stored in the SIM card using the portable terminal according to an embodiment of the present invention.

First, the control section 110 determines whether the first SIM card 50 is connected to the SIM interface 120 (S110). If it is determined that the first SIM card 50 is connected to the SIM interface 120, the control section 110 recognizes the first SIM card 50 as the exterior storage medium and registers the first SIM card 50 (S120).

At this time, the control section 110 detects the data lists stored in the first SIM card 50 so as to display the detected lists via the display section 190, and determines the type of stored data (S130). Further, the control section 110 determines whether a signal generated by selecting a menu key installed for providing a service is inputted via the operation key 170 (S140).

If it is determined that the signal is inputted via the operation key 170, the control section 110 detects a data list corresponding to the selected service menu key from among the data lists stored in the storage section 160, and displays the detected data list via the display section 190 (S150). At this time, the control section 110 determines whether a command calling for storage in the internal storage medium of a list from among the displayed list and data corresponding to the selected list is inputted from the SIM control key 174 of the operation key 170 (S160), which is shown in FIG. 4.

As shown in FIG. 4, when it is determined that the command, which calls for storage of a selected list and data corresponding to the selected list has been inputted via the SIM control key 174, the control section 110 detects data corresponding to the selected list from the first SIM card 50 and stores the detected data in the storage section 160 of the internal storage medium (S170). The data, which are detected from the first SIM card 50 to be stored in storage section 160, are called the SIM data 164.

After the data detected from the first SIM card 50 are stored in storage section 160, the control section 110 determines whether the first SIM card 50 is separated, i.e. removed, from the SIM interface 120 (S180). If it is determined that the first SIM card 50 is separated from the SIM interface 120 and that the second SIM card 60 is connected to the SIM interface 120, the control section 110 performs an initialization process and registers the second SIM card 60 as an exterior storage medium. Further, the control section 110 deletes the registered exterior storage medium list and determines the type of data stored in the second SIM card 60. At this time, if a command calling for the display of SIM data 164, which was transferred from the first SIM card 50 and is stored in the storage section 160 of the internal storage medium to be displayed, is inputted, the control section 110 will display lists of the SIM data 164 stored in the storage section 160 (S190).

Next, the control section 110 determines whether a command is input via the SIM control key 174 (S210) calling for storage of a selected list from among the displayed lists of the SIM data. If it is determined that such command is input, the control section 110 detects SIM data corresponding to the selected list from the storage section 160 in order to store the detected data in the second SIM card 60 (S220).

If in step S160, it was determined that a command, which requires the list to be selected from among the displayed list and the data corresponding to the selected list to be stored in the internal storage medium, was not inputted via the SIM control key 174, the control section 110 determines whether a command, which requires a list to be selected and the selected list to be displayed, is inputted (S240). If it is determined that the command, which requires the list to be selected and the selected list to be displayed, is inputted, the control section 110 detects data corresponding to the selected list from the second SIM card 60 to display the detected data via the display section 190 (S250).

At this time, the control section 110 determines whether a storage command for the data, which are detected from the second SIM card 60 and are then displayed, is inputted (S260). If it is determined that the storage command is inputted, the control section 110 stores the displayed data in the storage section 160 of the internal storage medium (S270). After a storage operation for the displayed data has been completed, the control section 110 performs the operations in step S180 to S220, as described above.

As described above, the data stored in the first SIM card 50 are selectively stored in the storage section 160 of the internal storage medium. Then, when the first SIM card 50 is removed and a second SIM card 60 is mounted on the portable terminal, the data stored in storage section 160, which was detected from the first SIM card 50, can be selectively stored in the second SIM card 60. Accordingly, the data stored in the first SIM card 50 can be easily copied into and stored in the second SIM card 60.

According to the present invention, a SIM card mounted on a portable terminal is recognized, allowing data stored in the SIM card to be automatically or selectively stored in an internal storage medium of the portable terminal. If another SIM card is then mounted on the portable terminal, the data stored in the internal storage medium can automatically or selectively be stored in the newly mounted SIM card. Accordingly, the data stored in the SIM card can be easily copied to the another SIM card without connecting the SIM card to or use of another device. Furthermore, even when a user replaces a SIM card mounted on the portable terminal with another SIM card, data which have been stored in the SIM card can be easily moved and stored in the other SIM card.

Also, data stored in a first SIM card are selectively stored in a storage section of an internal storage medium, and the data stored in the storage section after being detecting from the first SIM card are selectively stored in a second SIM card when the second SIM card is newly mounted on the portable terminal, so that the data stored in the first SIM card can be easily copied into and stored in the second SIM card.

While the invention has been shown and described with reference to certain preferred embodiments thereof, it will be understood by those skilled in the art that various changes in form and details may be made therein without departing from the spirit and scope of the invention as defined by the appended claims.

1. A portable terminal which can detachably house a subscriber identification module (SIM) card, the portable terminal comprising:
a SIM interface for connecting the SIM card, and for providing an interface for exchanging data between the portable terminal and the SIM card;
an operation key including a service menu key and a SIM control key, wherein the SIM control key controls data exchange to the SIM card connected to the SIM interface;
a storage section for storing data transferred from the SIM card and data type information; and
a control section for controlling transfer of data from a first SIM card to the storage section of the portable terminal, and for controlling transfer of the stored data to a second SIM card when the second SIM card is connected to the SIM interface.

2. The portable terminal as claimed in claim 1, wherein the control section detects lists of data stored in the SIM card connected to the SIM interface,
determines the type of detected data stored in the connected SIM card,
displays a list from among the detected lists corresponding to an input made by a user via the service menu key,
detects data from the SIM card to store in the storage section, the data corresponding to the list selected by the user, and
selectively stores the selected data in the storage section.

3. The portable terminal as claimed in claim 1, wherein the second SIM card is connected to the SIM interface after the first SIM card is disconnected from the SIM interface.

4. The portable terminal as claimed in claim 2, wherein the data stored in the storage section after being detected from the SIM card includes at least one of a short message, an electronic book, a picture, a dynamic image, and music information.

5. A method for copying subscriber identification module data stored in a subscriber identification module (SIM) card using a portable terminal, the portable terminal including a SIM interface connected to the SIM card, an operation key having a service menu key and a SIM control key, wherein the SIM control key controls data exchange to the SIM card, and a storage section for storing data transferred from the SIM card and data type information, the method comprising the steps of:
determining whether the SIM card is connected to the SIM interface;
detecting data stored in the SIM card to store the detected data in an internal storage medium of the storage section when it is determined that the SIM card is connected to the SIM interface; and
detecting whether data is stored in the internal storage medium and selectively storing the detected data in another SIM card when the another SIM card is connected to the SIM interface.

6. The method as claimed in claim 5, further comprising:
detecting lists of the data stored in the SIM card and determines the type of detected data when it is determined that the SIM card is connected to the SIM interface;
displaying a list from among the detected lists corresponding to a selection signal input by a user; and
detecting data corresponding to a selected list from the SIM card and storing the detected data in the internal storage medium according to a storage command input by the user.

7. The method as claimed in claim 6, further comprising:
detecting the data corresponding to the selected list from the SIM card and displaying the detected data according to a display command input by the user; and
storing the displayed data in the internal storage medium when a storage command, is input by the user.
